(19) United States
(12) Patent Application Publication
(10) Pub. No.: US 2008/0103067 A1
(43) Pub. Date: May 1, 2008

(54) Hydrolytically and Hydrothermally Stable Consolidated Proppants and Method for the Production Thereof

(75) Inventors: Helmut Schmidt, Saarbruecken-Guedingen (DE); Bernd Reinhard, Merzig-Brotdorf (DE); Klaus Endres, Homburg (DE); Jens Adam, Saarbruecken (DE)

Correspondence Address: GREENBLUM & BERNSTEIN, P.L.C., 1950 ROLAND CLARKE PLACE, RESTON, VA, 20191, US

(73) Assignee: KRAIBURG GEOTECH GMBH, Saarbruecken (DE)

(21) Appl. No.: 11/814,363

(22) PCT Filed: Jan. 19, 2006
(86) PCT No.: PCT/EP06/00463

§ 371 Date: Oct. 10, 2007

(30) Foreign Application Priority Data
Jan. 20, 2005 (DE) 10 2005 002 806.3

(51) Int. Cl. C09K 8/80

(52) U.S. Cl. 507/204; 507/234

(57) ABSTRACT

A process is described for preparing hydrolytically and hydrothermally stable, consolidated proppants, in which (A) a consolidant comprising a hydrolyzate or precondensate of at least one organosilane, a further hydrolyzable silane and at least one metal compound, where the molar ratio of silicon compounds used to metal compounds used is in the range from 10 000:1 to 10:1, is blended with a proppant or infiltrated or injected into the geological formation, and (B) the consolidant is cured under conditions of elevated pressure and elevated temperature.

The invention relates to a process for preparing hydrothermally consolidated and hydrolytically stable, consolidated proppants.

Binders are of high significance especially for the binding of compact or particulate products. In the mineral oil industry, particularly the process of fracturing has proven itself for enhancing and stabilizing the oil extraction output in oil-containing deposits. For this purpose, an artificial gap is first generated around the borehole in the oil-bearing formation by means of a highly viscous fracture fluid. In order that this gap remains open, the highly viscous fluid is provided with so-called proppants which, after the removal of the pressure which is needed to generate and maintain the formation gap, maintain the gap as a region with increased porosity and permeability. Gaps and cracks are also referred to hereinafter as “fractures”. Proppants are especially sands and ceramic particles of a diameter from several 100 μm to a few millimeters, which are positioned in the rock gap. In general, these proppants have to be reinforced in order to prevent flowback with the extracted oil. For this purpose, binders which first cure and have long-term stability in the oil extraction under the conditions of the developed reservoir (high pressure at high temperature, endogenous groundwater and aggressive components in the crude oils and gases) are required.

For efficient use of binders, it is important that the stability is maintained for as long as possible under the abovementioned aggressive conditions, in the course of which the binding strength and the porosity must not be reduced significantly. The systems mentioned in the prior art, nearly all of which are based on organic polymers, have a very limited lifetime in this regard.

The consolidation of proppants with suitable binders is difficult especially when the consolidated proppants, compared to the proppants without binder, are not to lose porosity to a significant degree. For example, it is possible to produce porous composites with organic polymer binders, but it is found that it is barely possible to maintain the original porosity. In the case of reduced binder use, it is possible to prepare porous systems, but such composites are unsuitable for many applications, especially at relatively high temperatures and in an environment of organic liquids, owing to the property of the organic polymers to swell or to go into solution in the presence of organic solvents.

The use of purely inorganic binders, which are obtainable, for example, via the sol-gel process, does lead to a bond in which an appropriate porosity is maintained in the proppant, but the bonded system is very brittle, crumbly and insufficiently resistant to mechanical stresses such as shear stresses or high pressure stresses.

Moreover, it is frequently appropriate to prepare proppants under the conditions under which they are also employed later. It is therefore frequently necessary to cure the proppants on site after introduction into the fracture under the geological pressure and temperature conditions. For many consolidants, this is possible only with loss of the necessary hydrolysis stabilities, if at all.

It was an object of the invention to provide processes for preparing consolidated proppants under hydrothermal conditions of reservoirs, which are hydrolysis- and corrosion-stable especially under these pressure and temperature conditions, such that their functionality is maintained over several years. In the curing process under these hydrothermal conditions, the porosity and permeability—compared to the unsolidified proppants—should for the most part be maintained with simultaneously high bond strength.

The object is achieved by a process for preparing hydrolytically and hydrothermally stable consolidated proppants, in which

(A) a consolidant comprising a hydrolyzate or precondensate of

(a) at least one organosilane of the general formula (I)
   RₙSiX₄₋ₙ (I)
in which the R radicals are the same or different and are hydrolytically non-removable groups, the X radicals are the same or different and are hydrolytically removable groups or hydroxyl groups, and n has the value of 1, 2 or 3,
(b) at least one hydrolyzable silane of the general formula (II)
   SiX₄ (II)
in which the X radicals are each as defined above; and
(c) at least one metal compound of the general formula (III)
   MXₐ (III)
in which M is a metal of main groups I to VIII or of transition groups II to VIII of the Periodic Table of the Elements including boron, X is as defined in formula (I), where two X groups may be replaced by an oxo group, and a corresponds to the valency of the elements;
where the molar ratio of silicon compounds used to metal compounds used is in the range from 10 000:1 to 10:1
   is blended with a proppant and
   (B) the consolidant is cured under conditions of elevated pressure and elevated temperature.

Detailed investigations have shown that the proppants bound in accordance with the invention are not degraded even in an autoclave at high pressure and high temperature even over a prolonged period, and a stable bond is still maintained even under these conditions.

The use of hydrolyzable metal compounds of the formula (III) surprisingly brings two advantages: in the case of consolidants which comprise these metal compounds, compared to those without this metal compound, a particularly good hydrolysis stability of the cured consolidants under hydrothermal conditions is found.

A further advantage consists in the fact that consolidants which comprise such metals can also be cured under elevated pressure, as explained in detail below.

Proppants have already been explained in general terms above and are common knowledge to those skilled in the art in the field. They are pellets or particles which are frequently essentially spherical. They generally have, for instance, a mean diameter of several hundred micrometers, for example in the range between 1000 and 1 μm. The proppants may, for example, be coarse sand, ceramic proppants, for example of Al₂O₃, ZrO₂ or mullite, natural products such as walnut shells, or metal or plastic particles such as aluminum or nylon pellets. The proppants are preferably sand or ceramic particles.

Suitable examples of hydrolytically removable groups X of the above formulae are hydrogen, halogen (F, Cl, Br or I, in particular Cl or Br), alkoxy (e.g. C₁₋₆-alkoxy, for example methoxy, ethoxy, n-propoxy, i-propoxy and n-, i-, sec- or tert-butoxy), aryloxy (preferably C₆₋₁₀-aryloxy, for example phenoxy), alkaryloxy, for example benzoyloxy, acyloxy (e.g. C₁₋₆-acyloxy, preferably C₁₋₄-acyloxy, for example acetoxy or propionyloxy) and alkylcarbonyl (e.g. C₂₋₇-alkylcarbonyl such as acetyl). Likewise suitable are NH₂, mono- or di-alkyl-, -aryl- and/or -aralkyl-substituted amino, examples of the alkyl, aryl and/or aryalkyl radicals being specified below for R, amido such as benzamido or aldoxime or ketoxime groups. Two or three X groups may also be joined to one another, for example in the case of Si-polyol complexes with glycol, glycerol or pyrocatechol. The groups mentioned may optionally contain substituents such as halogen, hydroxyl, alkoxy, amino or epoxy.

Preferred hydrolytically removable radicals X are halogen, alkoxy groups and acyloxy groups. Particularly preferred hydrolytically removable radicals are C₂₋₄-alkoxy groups, especially ethoxy.

The hydrolytically nonremovable radicals R of the formula (I) are, for example, alkyl (e.g. C₁₋₂₀-alkyl, in particular C₁₋₄-alkyl, such as methyl, ethyl, n-propyl, i-propyl, n-butyl, i-butyl, sec-butyl and tert-butyl), alkenyl (e.g. C₂₋₂₀-alkenyl, especially C₂₋₄-alkenyl, such as vinyl, 1-propenyl, 2-propenyl and butenyl), alkynyl (e.g. C₂₋₂₀-alkynyl, especially C₂₋₄-alkynyl, such as ethynyl or propargyl), aryl (especially C₆₋₁₀-aryl, such as phenyl and naphthyl) and corresponding aralkyl and alkaryl groups such as tolyl and benzyl, and cyclic C₃₋₁₂-alkyl and -alkenyl groups such as cyclopropyl, cyclopentyl and cyclohexyl.

The radicals R may have customary substituents which may be functional groups, by virtue of which cross-linking of the condensate via organic groups is also possible if required. Customary substituents are, for example, halogen (e.g. chlorine or fluorine), epoxide (e.g. glycidyl or glycidyloxy), hydroxyl, ether, ester, amino, monoalkylamino, dialkylamino, optionally substituted anilino, amide, carboxyl, alkenyl, alkynyl, acryloyl, acryloyloxy, methacryloyl, methacryloyloxy, mercapto, cyano, alkoxy, isocyanato, aldehyde, keto, alkylcarbonyl, acid anhydride and phosphoric acid. These substituents are bonded to the silicon atom via divalent bridging groups, especially alkylene, alkenylene or arylene bridging groups which may be interrupted by oxygen or NH groups. The bridging groups contain, for example, from 1 to 18, preferably from 1 to 8 and in particular from 1 to 6 carbon atoms. The divalent bridging groups mentioned derive, for example, from the abovementioned monovalent alkyl, alkenyl or aryl radicals. Of course, the R radical may also have more than one functional group.

Preferred examples of hydrolytically nonremovable radicals R with functional groups, by virtue of which crosslinking is possible, are a glycidyl- or a glycidyloxy-(C₁₋₂₀)-alkylene radical such as β-glycidyloxyethyl, γ-glycidyloxypropyl, δ-glycidyloxybutyl, ε-glycidyloxypentyl, ω-glycidyloxyhexyl and 2-(3,4-epoxycyclohexyl)ethyl, a (meth)acryloyloxy-(C₁₋₆)-alkylene radical, e.g. (meth)acryloyloxymethyl, (meth)acryloyloxyethyl, (meth)acryloyloxypropyl or (meth)acryloyloxybutyl, and a 3-isocyanatopropyl radical. Particularly preferred radicals are γ-glycidyloxypropyl and (meth)acryloyloxypropyl. Here, (meth)acryloyl represents acryloyl and methacryloyl.

Preferred radicals R which are used are radicals without substituents or functional groups, especially alkyl groups, preferably having from 1 to 4 carbon atoms, especially methyl and ethyl, and also aryl radicals such as phenyl.

Examples of organosilanes of the general formula (I) are compounds of the following formulae, particular preference being given to the alkylsilanes and especially methyltriethoxysilane:
CH₃—SiCl₃, CH₃—Si(OC₂H₅)₃, C₂H₅—SiCl₃, C₂H₅—Si(OC₂H₅)₃, C₃H₇—Si(OC₂H₅)₃, C₆H₅—Si(OC₂H₅)₃, (C₂H₅O)₃—Si—C₃H₆—Cl, (CH₃)₂SiCl₂, (CH₃)₂Si(OC₂H₅)₂, (CH₃)₂Si(OH)₂, (C₆H₅)₂SiCl₂, (C₆H₅)₂Si(OC₂H₅)₂, (i-C₃H₇)₃SiOH, CH₂═CH—Si(OOCCH₃)₃, CH₂═CH—SiCl₃, CH₂═CH—Si(OC₂H₅)₃, CH₂═CHSi(OC₂H₅)₃, CH₂═CH—Si(OC₂H₄OCH₃)₃, CH₂═CH—CH₂—Si(OC₂H₅)₃, CH₂═CH—CH₂—Si(OC₂H₅)₃, CH₂═CH—CH₂—Si(OOCCH₃)₃, CH₂═C(CH₃)COO—C₃H₇—Si(OC₂H₅)₃, n-C₆H₁₃—CH₂—CH₂—Si(OC₂H₅)₃, n-C₈H₁₇—CH₂—CH₂—Si(OC₂H₅)₃, (C₂H₅O)₃Si—(CH₂)₃—O—CH₂

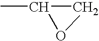

Examples of the hydrolyzable silanes of the general formula (II) are Si(OCH₃)₄, Si(OC₂H₅)₄, Si(O-n- or i-C₃H₇)₄, Si(OC₄H₉)₄, SiCl₄, HSiCl₃, Si(OOCCH₃)₄. Among these hydrolyzable silanes, particular preference is given to tetraethoxysilane.

The silanes can be prepared by known methods; cf. W. Noll, “Chemie und Technologie der Silicone” [Chemistry and Technology of the Silicones], Verlag Chemie GmbH, Weinheim/Bergstraβe (1968).

In the metal compound of the general formula (III)
MXₐ (III),
M is a metal of main groups I to VIII or of transition groups II to VIII of the Periodic Table of the Elements including boron, X is as defined in formula (I), where two X groups may be replaced by an oxo group, and a corresponds to the valence of the element.

M is different from Si. Boron is also included here in the metals. Examples of such metal compounds are compounds of the glass- or ceramic-forming elements, especially compounds of at least one element M from main groups III to V and/or transition groups II to IV of the Periodic Table of the Elements. They are preferably hydrolyzable compounds of Al, B, Sn, Ti, Zr, V or Zn, especially those of Al, Ti or Zr, or mixtures of two or more of these elements. It is likewise possible to use, for example, hydrolyzable compounds of elements of main groups I and II of the Periodic Table (e.g. Na, K, Ca and Mg) and of transition groups V to VIII of the Periodic Table (e.g. Mn, Cr, Fe and Ni). It is also possible to use hydrolyzable compounds of the lanthanoids such as Ce. Preference is given to metal compounds of the elements B. Ti, Zr and Al, particular preference being given to Ti.

Preferred metal compounds are, for example, the alkoxides of B, Al, Zr and especially Ti. Suitable hydrolyzable metal compounds are, for example, Al(OCH₃)₃, Al(OC₂H₅)₃, Al(O-n-C₃H₇)₃, Al(O-i-C₃H₇)₃, Al(O-n-C₄H₉)₃, Al(O-sec-C₄H₉)₃, AlCl₃, AlCl(OH)₂, Al(OC₂H₄OC₄H₉)₃, TiCl₄, Ti(OC₂H₅)₄, Ti(O-n-C₃H₇)₄, Ti(O-i-C₃H₇)₄, Ti(OC₄H₉)₄, Ti(2-ethylhexoxy)₄, ZrCl₄, Zr(OC₂H₅)₄, Zr(O-n-C₃H₇)₄, Zr(O-i-C₃H₇)₄, Zr(OC₄H₉)₄, ZrOCl₂, Zr(2-ethylhexoxy)₄, and also Zr compounds which have complexing radicals, for example β-diketone and (meth)acryloyl radicals, sodium ethoxide, potassium acetate, boric acid, BCl₃, B(OCH₃)₃, B(OC₂H₅)₃, SnCl₄, Sn(OCH₃)₄, Sn(OC₂H₅)₄, VOCl₃ and VO(OCH₃)₃.

In a particularly preferred embodiment, the consolidant is prepared using an alkylsilane such as methyltriethoxysilane (MTEOS), an arylsilane such as phenyltriethoxysilane and an orthosilicic ester such as tetraethoxysilane (TEOS) and a metal compound of the formula (III), particular preference being given to the use of a metal compound of B, Al, Zr and especially Ti.

To prepare the consolidant, preference is given to using at least 50 mol %, more preferably at least 70 mol % and in particular at least 80 mol % of organosilanes of the formula (I) with at least one hydrolytically nonremovable group. The rest are hydrolyzable compounds, especially the metal compounds of the formula (III) and optionally the hydrolyzable silanes of the formula (II) which do not have any hydrolytically nonremovable groups.

The molar ratio of silicon compounds of the formulae (I) and (II) used to metal compounds of the formula (III) used is in the range from 10 000:1 to 10:1, particularly good hydrolysis stability being achieved in the range from 2000:1 to 20:1 and more preferably from 2000:1 to 200:1.

For the calculation of the molar fractions or ratios which are specified above, the starting materials for the compounds are in each case the monomeric compounds. When, as explained below, the starting materials used are already precondensed compounds (dimers, etc.), it is necessary to convert to the corresponding monomers.

The hydrolyzates or precondensates of the consolidant are obtained from the hydrolyzable silanes and the hydrolyzable metal compounds by hydrolysis and condensation. Hydrolyzates or precondensates are understood to mean in particular hydrolyzed or at least partly condensed compounds of the hydrolyzable starting compounds. Instead of the hydrolyzable monomer compounds, it is also possible to use already precondensed compounds as reactants in the synthesis of the consolidant. Such oligomers which are preferably soluble in the reaction medium may, for example, be straight-chain or cyclic low molecular weight partial condensates (e.g. polyorganosiloxanes) with a degree of condensation of, for example, from about 2 to 100, in particular from about 2 to 6.

The hydrolyzates or precondensates are preferably obtained by hydrolysis and condensation of the hydrolyzable starting compounds by the sol-gel process. In the sol-gel process, the hydrolyzable compounds are hydrolyzed and at least partly condensed with water, optionally in the presence of acidic or basic catalysts. Preference is given to effecting the hydrolysis and condensation in the presence of acidic condensation catalysts (e.g. hydrochloric acid, phosphoric acid or formic acid) at a pH of preferably from 1 to 3. The sol which forms may be adjusted to the viscosity desired for the consolidant by virtue of suitable parameters, for example degree of condensation, solvent or pH.

Further details of the sol-gel process are described, for example, in C. J. Brinker, G. W. Scherer: “Sol-Gel Science—The Physics and Chemistry of Sol-Gel-Processing”, Academic Press, Boston, San Diego, New York, Sydney (1990).

For the hydrolysis and condensation, it is possible to use stoichiometric amounts of water, but also smaller or greater amounts may be used. Preference is given to employing a substoichiometric amount of water based on the hydrolyzable groups present. The amount of water used for the hydrolysis and condensation of the hydrolyzable compounds is preferably from 0.1 to 0.9 mol and more preferably from 0.25 to 0.75 mol of water per mole of the hydrolyzable groups present. Particularly good results are often achieved with less than 0.7 mol of water, in particular from 0.55 to 0.65 mol of water, per mole of hydrolyzable groups present.

The consolidant used in accordance with the invention is present in particular in particle-free form as a solution or emulsion. Before use, the consolidant may be activated by addition of a further amount of water.

The consolidant may contain conventional additives and solvents such as water, alcohols, preferably lower aliphatic alcohols (C₁-C₈-alcohols), such as methanol, ethanol, 1-propanol, isopropanol and 1-butanol, ketones, preferably lower dialkyl ketones, such as acetone and methyl isobutyl ketone, ethers, preferably lower dialkyl ethers, such as diethyl ether, or mono-ethers of diols, such as ethylene glycol or propylene glycol, with C₁-C₈-alcohols, amides such as dimethyl-formamide, tetrahydrofuran, dioxane, sulfoxides, sulfones or butylglycol and mixtures thereof. Preference is given to using water and alcohols. It is also possible to use high-boiling solvents, for example polyethers such as triethylene glycol, diethylene glycol diethyl ether and tetraethylene glycol dimethyl ether. In some cases, other solvents also find use, for example light paraffins (petroleum ether, alkanes and cycloalkanes), aromatics, heteroaromatics and halogenated hydrocarbons. It is also possible to use dicarboxylic esters such as dimethyl succinate, dimethyl adipate, dimethyl glutarate and mixtures thereof, and also the cyclic carboxylic esters, for example propylene carbonate and glyceryl carbonate.

Other conventional additives are, for example, dyes, pigments, viscosity regulators and surfactants. For the preparation of emulsions of the consolidant, it is possible to employ the stabilizing emulsifiers customary in silicone emulsions, for example Tween® 80 and Brij® 30.

To produce consolidated proppants, the consolidant is either blended with the proppants to be consolidated, for example by mixing or pumping-in, or, after the positioning of the proppant in the fracture, injected into the proppant-bearing formation gap and subsequently cured.

The consolidation (curing) is effected under elevated temperature and elevated pressure based on standard conditions, i.e. the pressure is greater than 1 bar and the temperature is higher than 20° C. Preference is given to curing the consolidant at a temperature and a pressure which correspond approximately to the geological conditions of the reservoir in which the proppants are used, generally at temperatures above 40° C. and at least 8 bar. Depending upon the formation depth, temperatures up to 160° C. and pressures up to 500 bar may be needed for the curing.

It is known that thermal curing of consolidants under ambient pressure is quite unproblematic. The continuous removal of the solvent and of the water reaction product from the mixture of binder sol and material to be consolidated results in a progressing condensation reaction. In the further thermal curing process, the consolidant is compacted on the material to be consolidated.

However, the properties of consolidated materials also depend upon the conditions under which they are produced. In general, improved performance of the consolidated materials is obtained when they are produced under approximately the same conditions under which they are to be used. For applications of consolidated materials at elevated pressures and temperatures, it is therefore desirable also to carry out the production under approximately the same conditions. However, this is problematic for the prior art consolidants, since, in the course of curing of prior art consolidants at elevated pressure and elevated temperature, i.e. under hydrothermal conditions, solvents and reaction products remain in the system and merely enable a shift in the equilibrium. However, the equilibrium position under these conditions does not afford consolidated materials.

It has been found that, surprisingly, the equilibrium position is changed by the use of metal compounds of the formula (III), so that setting of the consolidant used became possible under hydrothermal conditions (elevated pressure and elevated temperature). In this way, it is possible to obtain consolidated proppants under hydrothermal conditions, the consolidated proppants having good binding stabilities with sufficient flexibility.

The curing of the consolidant under hydrothermal conditions may also be promoted by addition of anhydrides to the consolidant. With the aid of the anhydrides, condensation products such as water and ethanol can be scavenged. The anhydrides are preferably anhydrides of organic acids or mixtures of these anhydrides. Examples are acetic anhydride, methylnadic anhydride, phthalic anhydride, succinic anhydride and mixtures thereof.

In the case of addition of anhydrides, preference is given to using, for example, cyclic carbonic esters such as propylene carbonate, or carboxylic esters such as dimethyl glutarate, dimethyl adipate and dimethyl succinate, or dimethyl dicarboxylate mixtures of the esters mentioned as a solvent. In general, it is possible for this purpose to fully or partly exchange the suitable solvent for the solvent used or formed in the preparation of the consolidant. In addition to the solvent exchange, it is also possible to use a preferred solvent as early as in the preparation of the consolidant.

The curing of proppants to be consolidated is thus possible under hydrothermal conditions.

Since a compaction operation of the gelled consolidant is completely or partly prevented under hydrothermal conditions, the consolidant gel can frequently seal the pores in large volumes. This can preferably be prevented or eliminated by passing a solid or liquid medium into the proppant which is to be consolidated and is mixed with the consolidant, which can adjust the porosity in the desired manner. The introduction is effected especially before or during the curing operation over a certain period.

Parameters for the through-pumping, such as duration, time, amount or through-flow rate of the liquid or gaseous phase can be selected by those skilled in the art in a suitable manner directly, in order to establish the desired porosity. The introduction can be effected, for example, before or after partial curing, in which case full curing is effected after and/or during the introduction. To introduce a liquid or gaseous medium, it is possible, for example, to pump in an inert solvent or gas, for example N₂, CO₂ or air, which clears the pore volumes by purging and removes reaction products. As examples of solvents for the liquid medium, reference may be made to those listed above. The liquid or gaseous medium may optionally comprise catalysts and/or gas-releasing components.

The curing of the consolidant can optionally be promoted by supplying condensation catalysts which bring about crosslinking of the inorganically cross-linkable SiOH groups or metal-OH groups to form an inorganic network. Condensation catalysts suitable for this purpose are, for example, bases or acids, but also fluoride ions or alkoxides. These may be added, for example, to the consolidant shortly before the mixing with the proppant. In a preferred embodiment, the above-described gaseous or liquid media which are passed through the proppant or the geological formation are laden with the catalyst. The catalyst is preferably volatile, gaseous or evaporable. The catalyst may comprise dissolved substances, for example zirconium oxychloride, and be metered to the binder in the form of a gradient.

The consolidated proppants are preferably porous, the porosity of the consolidated proppants (ratio of volume of the pores to the total volume of the proppant) being preferably from 5 to 50% and more preferably from 20 to 40%.

To experimentally simulate the geological conditions, the properties of consolidant and consolidated proppants are preferably characterized by using a so-called “displacement cell” used customarily in the oil industry. In this cell, a cylindrical specimen which comprises the proppant to be consolidated, via the outer surface made of lead, is subjected to a confinement pressure which simulates the geological formation pressure (e.g. 70 bar) and compacted. Via the end surfaces of the sample cylinder, the media are introduced and discharged against an opposing pressure of, for example, 50 bar. For thermal curing, the cell is temperature-controlled. The resulting porosity and permeability attain more than 80% of the original values with strengths up to 1.6 MPa. The strength is retained even after storage of the shaped body under hydrothermal conditions in corrosive media.

The inventive proppants can be used advantageously in gas, mineral oil or water extraction, especially offshore extraction.

Owing to its chemical constitution, the inventive consolidant enables rapid and effective consolidation. In this connection, the use of phenylsilane alkoxides has been found to be particularly useful. The reason for this is suspected to be that these compounds, owing to the steric hindrance of the phenyl group and the electronic effects, do not have rapidly reacting OH groups, which bond particularly efficiently with the surface of inorganic materials.

Using the consolidant, it is possible to obtain bound porous proppants in which the porosity is generated or maintained by blowing in a medium such as air which has optionally been admixed with volatile catalysts. When an attempt is made, after the introduction of the consolidant which is yet to be cured, to cure it by introducing liquid catalysts, curing does occur but the pores are blocked by the cured consolidant.

The example which follows illustrates the invention.

### EXAMPLE

### Preparation of Particle-Free Consolidants and their Use for Proppant Bridging (Hydrothermal)

a) Consolidant MTTi_{0.1}P₃ 06

26.2 g of MTEOS, 7.64 g of TEOS and 0.087 g of titanium tetraisopropoxide were mixed and reacted under vigorous stirring with 12.63 g of deionized water and 0.088 ml of concentrated hydrochloric acid (37%). After the changeover point, the reaction mixture exceeded a temperature maximum of 62° C. After cooling of the reaction mixture to 47° C., a further silane mixture which consists of 26.45 g of phenyltriethoxysilane, 6.54 g of MTEOS and 7.64 g of TEOS was added to the mixture and stirred further for another 5 minutes. After standing overnight, the binder is suitable for consolidating proppants under hydrothermal conditions. Depending on the requirements, the pH may be adjusted within the range between pH 0 and 7.

To this end, for example, 100 g of proppants were mixed with 10 g of toluene and packed into a cylinder-shaped lead sleeve. The planar top ends of the cylinder were covered with a wire screen. In a displacement cell, the specimen was compacted with the aid of a pressure of 250 bar (confinement pressure) applied to the lead casing for 1 h. Subsequently, the binder was injected into the proppant body at 120° C. with a flow rate of 0.5 ml at a confinement pressure of 70 bar and against an opposing pressure of 20 bar applied with an N₂ gas bottle. After injection of two pore volumes of binder, the porosity was established by blowing in N₂ for 30 minutes and curing for 14 h. The resulting moldings exhibit compressive strengths in the range from 0.3 to 0.5 MPa and a porosity between 36 and 40%.

b) Consolidant MTTi_{0.1}P₃ 06/MTTi_{0 1}P₃ 06 (HCl_{1%}ZrOCl_{2 0.1%})

The consolidant described under a) affords, in a two-stage injection, compressive strengths between 0.7 and 1.4 MPa. To this end, one pore volume of the consolidant MTTi_{0.1}P₃ 06 and one further pore volume of MTTi_{0 1}P₃ 06, which had been admixed beforehand with a mixture which consists of 1% by weight of 37% hydrochloric acid and 0.1% by weight of zirconium oxychloride (based on the binder), were injected into the proppant body under the preparation and process conditions described in a).

c) Consolidant MTTi_{0 1}P₃ 06 Conc.

The binder described under a) was concentrated on a rotary evaporator by distilling off ethanol up to a solids content of 45%. The resulting binder was injected into a proppant body and cured as described in a). This resulted in compressive strengths of 0.3 MPa.

1.-13. (canceled)

14. A process for preparing a hydrolytically and hydrothermally stable consolidated proppant, wherein the process comprises blending the proppant with a consolidant and thereafter curing the consolidant under conditions of elevated pressure and elevated temperature, the consolidant comprising at least one of a hydrolyzate and a precondensate of
(a) at least one organosilane of formula (I)
RₙSiX₄₋ₙ (I)
in which the radicals R are the same or different and are each hydrolytically non-removable groups, the radicals X are the same or different and are each hydroxyl groups or hydrolytically removable groups and n is 1, 2 or 3,
(b) at least one hydrolyzable silane of formula (II)
SiX₄ (II)
in which the radicals X are each as defined above, and
(c) at least one metal compound of formula (III)
MXₐ (III)
in which M is a metal of main groups I to VIII or of transition groups II to VIII of the Periodic Table of the Elements including boron, X is as defined for formula (I), with the proviso that two radicals X may be replaced by one oxo group, and a corresponds to a valence of M,
where a molar ratio of compounds of formulae (I) and (II) to compound(s) of formula (III) is from 10,000:1 to 10:1.

15. The process of claim 14, wherein the consolidant is cured at a temperature of at least 40° C. and a pressure of at least 8 bar.

16. The process of claim 14, wherein the molar ratio of compounds of formulae (I) and (II) to compound(s) of formula (III) is from 2,000:1 to 20:1.

17. The process of claim 14, wherein the at least one compound of formula (III) comprises at least one of B, Al, Zr and Ti.

18. The process of claim 17, wherein the at least one compound of formula (III) comprises at least Ti.

19. The process claim 14, wherein at least one of before and during curing of the consolidant at least one of a liquid and gaseous medium is passed for a certain period through the proppant which is to be consolidated and has been blended with the consolidant in order to establish a porosity.

20. The process of claim 19, wherein the at least one of a liquid and gaseous medium comprises air.

21. The process of claim 19, wherein the at least one of a liquid and gaseous medium is laden with a catalyst which is at least one of volatile, gaseous and evaporable.

22. The process of claim 21, wherein the catalyst comprises at least one of an acid and a base.

23. The process of claim 14, wherein the proppant, after having been placed in a fracture, is consolidated by an injection and subsequent curing of the consolidant.

24. The process of claim 14, wherein the consolidant comprises at least one of a hydrolyzate and a precondensate of (a1) an alkylsilane, (a2) an arylsilane, (b) an orthosilicic ester and (c) a metal alkoxylate.

25. The process of claim 14, wherein the consolidant is prepared by a sol-gel process with a substoichiometric amount of water based on hydrolyzable groups present.

26. The process of claim 14, wherein before being blended with the proppant the consolidant is present in a substantially particle-free form.

27. The process of claim 14, wherein the proppant comprises at least one of pellets and particles of one or more of sand, ceramic, walnut shells, aluminum and nylon.

28. A process for preparing a hydrolytically and hydrothermally stable consolidated proppant, wherein the process comprises blending the proppant with a consolidant and thereafter curing the consolidant at a temperature of at least 40° C. and a pressure of at least 8 bar, the consolidant comprising at least one of a hydrolyzate and a precondensate of
(a) at least one organosilane of formula (I)
RₙSiX₄₋ₙ (I)
in which the radicals R are the same or different and are each hydrolytically non-removable groups, the radicals X are the same or different and are each hydroxyl groups or hydrolytically removable groups and n is 1, 2 or 3,
(b) at least one hydrolyzable silane of formula (II)
SiX₄ (II)
in which the radicals X are each as defined above, and
(c) at least one metal compound of formula (III)
MXₐ (III)
in which M is a metal of main groups I to VIII or of transition groups II to VIII of the Periodic Table of the Elements and comprises at least one of B, Al, Zr and Ti, X is as defined for formula (I), with the proviso that two radicals X may be replaced by one oxo group, and a corresponds to a valence of M,
where a molar ratio of compounds of formulae (I) and (II) to compound(s) of formula (III) is from 2000:1 to 20:1.

29. The process of claim 28, wherein the molar ratio is from 2000:1 to 200:1.

30. The process of claim 29, wherein the consolidant comprises at least one of a hydrolyzate and a precondensate of (a1) an alkylsilane, (a2) an arylsilane, (b) an orthosilicic ester and (c) a metal alkoxylate.

31. The process of claim 28, wherein at least 70 mole-% of compound(s) of formula (I) are employed.

32. The process of claim 31, wherein the at least one compound of formula (III) comprises at least Ti.

33. A consolidated proppant which is obtainable by the process of claim 14.

34. The consolidated proppant of claim 33, wherein the consolidated proppant is hydrolytically stable under hydrothermal conditions.

35. The consolidated proppant of claim 33, wherein the consolidated proppant is porous.

36. The consolidated proppant of claim 35, wherein the consolidated proppant has a porosity of from 5% to 50%.

37. The consolidated proppant of claim 33, wherein the consolidated proppant comprises at least one of pellets and particles of one or more of sand, ceramic, walnut shells, aluminum and nylon.

38. The consolidated proppant of claim 37, wherein the consolidant comprises at least one of a hydrolyzate and a precondensate of (a1) an alkylsilane, (a2) an arylsilane, (b) an orthosilicic ester and (c) a metal alkoxylate.
